(19) United States
(12) Patent Application Publication
(10) Pub. No.: US 2005/0140670 A1
(43) Pub. Date: Jun. 30, 2005

(54) Photogrammetric reconstruction of free-form objects with curvilinear structures

(76) Inventors: Hong Wu, Champaign, IL (US); Yizhou Yu, Champaign, IL (US)

Correspondence Address: Hong Wu, 1904 Robert Drive, Champaign, IL, 61821, US

(21) Appl. No.: 10/988,883

(22) Filed: Nov. 15, 2004

Related U.S. Application Data
(60) Provisional application No. 60/523,992, filed on Nov. 20, 2003.

(51) Int. Cl. G06T 15/00

(52) U.S. Cl. 345/419

(57) ABSTRACT

The shapes of many natural or man-made objects have curve features. The images of such curves usually do not have sufficient distinctive features to apply conventional feature-based reconstruction algorithms. In this paper, we introduce a photogrammetric method for recovering free-form objects with curvilinear structures. Our method chooses to define the topology and recover a sparse 3D wireframe of the object first instead of directly recovering a surface or volume model. Surface patches covering the object are then constructed to interpolate the curves in this wireframe while satisfying certain heuristics such as minimal bending energy. The result is an object surface model with curvilinear structures from a sparse set of images. We can produce realistic texture-mapped renderings of the object model from arbitrary viewpoints. Reconstruction results on multiple real objects are presented to demonstrate the effectiveness of our approach.

### REFERENCES CITED

### U.S. PATENT DOCUMENTS 60/523,992 November 2003 Yizhou Yu

### OTHER REFERENCES

[1] R. Berthilsson and K. Astrom. Reconstruction of 3d-curves from 2d-images using affine shape methods for curves. In IEEE Conference on Computer Vision and Pattern Recognition, 1997.
[2] R. Berthilsson, K. Astrom, and A. Heyden. Reconstruction of curves in R³, using factorization and bundle adjustment. In International Conference on Computer Vision, 1999.
[3] Canoma. www.canoma.com.
[4] R. Cipolla and A. Blake. Surface shape from the deformation of the apparent contour. Intl. Journal of Computer Vision, 9(2):83-112, 1992.
[5] P. E. Debevec, C. J. Taylor, and J. Malik. Modeling and rendering architecture from photographs: A hybrid geometry- and image-based approach. In SIGGRAPH '96, pages 11-20, 1996.
[6] M. Eck and H. Hoppe. Automatic reconstruction of b-spline surfaces of arbitrary topological type. In Computer Graphics (SIGGRAPH Proceedings), pages 325-329, 1996.
[7] O. Faugeras. Three-Dimensional Computer Vision. The MIT Press, Cambridge, Mass., 1993.
[8] O. Faugeras, S. Laveau, L. Robert, G. Csurka, and C. Zeller. 3-d reconstruction of urban scenes from sequences of images. In A. Gruen, O. Kuebler, and P. Agouris, editors, Automatic Extraction of Man-Made Objects from Aerial and Space Images. Birkhauser, 1995.
[9] P. Giblin and R. Weiss. Reconstruction of surfaces from profiles. In International Conference on Computer Vision, pages 136-144, 1986.
[10] R. Hartley and A. Zisserman. Multiple View Geometry in Computer Vision. Cambridge University Press, 2000.
[11] H. Hoppe, T. DeRose, T. Duchamp, M. Halstead, H. Jin, J. McDonald, J. Schweitzer, and W. Stuetzle. Piecewise smooth surface reconstruction. In Computer Graphics (SIGGRAPH Proceedings), pages 295-302, 1994.
[12] J. Hoschek and D. Lasser. Fundamentals of Computer Aided Geometric Design. AK Peters, Ltd., 1993.
[13] J. Kaminski, M.Fryers, A. Shashua, and M. Teicher. Multiple view geometry of non-planar algebraic curves. In International Conference on Computer Vision, 2001.
[14] V. Krishnamurthy and M. Levoy. Fitting smooth surfaces to dense polygon meshes. In Computer Graphics (SIGGRAPH Proceedings), pages 313-324, 1996.
[15] D. Liebowitz, A. Criminisi, and A. Zisserman. Creating architectural models from images. In Proc. of Eurographics, 1999.
[16] H. C. Longuet-Higgins. A computer algorithm for reconstructing a scene from two projections. Nature, 293:133-135, 1981.
[17] M. Mantyla. Introduction to Solid Modeling. W H Freeman & Co., 1988.
[18] Mok3. www.mok3.com.
[19] R. M. Murray, Z. Li, and S. S. Sastry. A Mathematical Introduction to Robotic Manipulation. CRC Press, 1994.
[20] T. Papadopoulo and O. Faugeras. Computing structure and motion of general 3d curves from monocular sequences of perspective images. In European Conference on Computer Vision, pages 696-708, 1996.
[21] P. Perona and J. Malik. Scale-space and edge detection using anisotropic diffusion. IEEE Trans. Patt. Anal. Mach. Intell., 12(7):629-639, 1990.
[22] E. Polak. Optimization—Algorithms and Consistent Approximations. Springer, 1997.
[23] P. Poulin, M. Ouimet, and M. C. Frasson. Interactively modeling with photogrammetry. In Eurographics workshop on rendering, 1998.
[24] M. J. D. Powell. A thin plate spline method for mapping curves into curves in two dimensions. In Computational Techniques and Applications, 1995.
[25] R. Ramamoorthi and P. Hanrahan. A signal-processing framework for inverse rendering. In Proceedings of SIGGRAPH, pages 117-128, 2001.
[26] Realviz—image processing software and solutions for content creation. www.realviz.com/products/im/index.php.
[27] L. Robert and R. Deriche. Dense depth map reconstruction: A minimization and regularization approach which preserves discontinuities. In European Conference on Computer Vision, 1996.
[28] Y. Sato, M. D. Wheeler, and K. Ikeuchi. Object shape and reflectance modeling from observation. In Computer Graphics Proceedings, Annual Conference Series, pages 379-388, 1997.
[29] C. Schmid and A. Zisserman. The geometry and matching of curves in multiple views. In European Conference on Computer Vision, 1998.
[30] S. Sullivan and J. Ponce. Automatic model construction and pose estimation from photographs using triangular splines. IEEE Trans. Pattern Analysis and Machine Intelligence, 20(10):1091-388, 1998.
[31] B. Triggs, P. McLauchlan, R. Hartley, and A. Fitzgibbon. Bundle adjustment—a modern synthesis. In Vision Algorithms: Theory and Practice, pages 298-375. Springer Verlag, 2000.
[32] R. Tsai. A versatile camera calibration technique for high accuracy 3d machine vision metrology using off-the-shelf tv cameras and lenses. IEEE Journal of Robotics and Automation, 3(4):323-344, 1987.
[33] Dragan Pubic, Patrick Hbert, and Denis Laurendeau. 3d surface modeling from range curves. In IEEE International Conference on Computer Vision and Pattern Recognition (CVPR 2003), 2003.
[34] G. Wahba. Spline models for observational data. SIAM, 1990.
[35] Y. Yu, P. Debevec, J. Malik, and T. Hawkins. Inverse global illumination: Recovering reflectance models of real scenes from photographs. In Proceedings of SIGGRAPH, pages 215-224, 1999.
[36] L. Zhang, G. Dugas-Phocion, J.-S. Samson, and S. M. Seitz. Single view modeling of free-form scenes. In Proc. Computer Vision and Pattern Recognition, 2001.
[37] D. Zorin, P. Schröder, and W. Sweldens. Interpolating subdivision for meshes with arbitrary topology. In Computer Graphics (SIGGRAPH Proceedings), pages 189-192, 1996.

### BACKGROUND OF THE INVENTION

One of the main thrusts of research in computer graphics and vision is to study how to reconstruct the shapes of 3-D objects from images and represent them efficiently. Nowadays, the techniques for reconstructing objects, which can be easily described by points and/or lines, have become relatively mature in computer vision, and the theory for representing curves and surfaces has also been well-developed in computer graphics. Nevertheless, reconstructing free-form natural or man-made objects still poses a significant challenge in both fields. One important subset of free-form objects have visually prominent curvilinear structures such as contours and curve features on surfaces. Intuitively, the two surface patches on different sides of a curvilinear feature should have a relatively large dihedral angle. More precisely, curvilinear features should have large maximum principal curvature. Because of this property, they are very often part of the silhouette of an object, and are very important in creating the correct occlusions between foreground and background objects as well as between different parts of the same object. As a result, unlike smooth free-form objects, the shape of an object with curvilinear features can be described fairly well by these features only. Such objects are ubiquitous in the real world, including natural objects such as leaves and flower petals as well as man-made objects such as architecture and furniture, automobiles and electronic devices. Therefore, a robust method for reconstructing such objects would provide a powerful tool for digitizing natural scenes and man-made objects.

3D image-based reconstruction methods can be classified as either automatic or photogrammetric. Automatic reconstruction methods include structure-from-motion and 3D photography. Structure from motion (SFM) tries to recover camera motion, camera calibration and the 3-D positions of simple primitives, such as points and lines, simultaneously via the well-established methods in multiple-view geometry [7, 10]. The recovered points and lines are unstructured and require a postprocessing stage for constructing surface models. On the other hand, 3D photography takes a small set of images with precalibrated camera poses, and is able to output surface or volume models directly. However, both methods typically require sufficient variations (texture or shading) on the surfaces to solve correspondences and achieve accurate reconstruction.

However, detecting feature points or curvilinear structures on free-form objects is often an error-prone process which prevents us from applying the automatic algorithms. Photogrammetric reconstruction, which allows the user to interactively mark features and their correspondences, comes handy at this point. Photogrammetric methods along with texture mapping techniques [8, 5, 23, 15] can effectively recover polyhedral models and simple curved surfaces, such as surfaces of revolution. A few commercial software packages [26, 3, 18] are available for photogrammetric reconstruction or image-based modeling and editing. Certain algorithmic details of the packages have not been made public. When the real object is a free-form object, even photogrammetric methods need a significant amount of effort to reach reasonable accuracy.

Photographs and range images have been the two major data sources for 3D object reconstruction. Acquiring high quality smooth object shapes based on range images has been a central endeavor within computer graphics. The initial data from a range scanner is a 3D point cloud which can be connected to generate a polygon mesh. Researchers have been trying to fit smooth surfaces to point clouds or meshes [11, 14, 6]. While these surface fitting techniques can generate high quality object models, obtaining the point clouds using range scanners is not always effective since range scanners cannot capture the 3D information of shiny or translucent objects very accurately. Furthermore, obtaining dense point clouds for objects with curvilinear structures is not always necessary, either, if a sparse wireframe can describe the shape fairly well. On the other hand, taking images using a camera tends to be more convenient, and is not subject to the same restrictions as range scanners.

In computer vision, while multiple-view geometry of points, lines, and planes have been extensively studied and well-understood, recent studies have gradually turned to use curves and surfaces as basic geometric primitives for modeling and reconstructing 3-D shapes. The difficulty in reconstruction of curves is that the point correspondences between curves are not directly available from the images because there are no distinct features on curves except the endpoints. An algorithm in [29] was proposed to automatically match individual curves between images using both photometric and geometric information. The techniques introduced in [20] aimed to recover the motion and structure for arbitrary curves from monocular sequences of images. Reconstruction of curves from multiple views based on an affine shape method was studied in [1, 2]. The reconstruction of algebraic curves from multiple views has also been proposed by [13].

There has also been much work in computer vision on reconstructing smooth surface models directly from silhouettes and/or curve constraints. Each silhouette generates a visual cone that is tangential to the object surface everywhere on the silhouette. The object surface can be reconstructed as the envelope of its tangent planes from a continuous sequence of silhouettes [9, 4]. The problem with silhouettes is that they are not static surface features and tend to change according to a moving viewpoint. Thus, the camera poses must be obtained independent of the silhouettes. In addition, concave regions on the surface cannot be accurately recovered. In [30], this approach is further extended and the whole object surface is covered with triangular splines deformed to be tangential to the visual cones. The strength of the extended approach lies in representing smooth free-form objects that do not have high-curvature feature curves. In the event that such salient curves are present, a larger number of images would be necessary to capture both the position and surface normal changes across them. In comparison, by explicitly representing these feature curves, our method can reconstruct shapes from less images, and can represent both convex and concave features equally well. In [33], a method is developed to reconstruct 3D surfaces from a set of unorganized range curves which may intersect with each other. It requires dense range curves as opposed to sparse salient curves.

A single view modeling approach was taken by [36] to reconstruct free-form surfaces. It solves a variational optimization to obtain a single thin-plate spline surface with internal curve constraints to represent depth as well as tangent discontinuities. The proposed technique is both efficient and user-friendly. Nevertheless, representing both foreground and background using a single spline surface is inadequate for most 3D applications where the reconstructed objects should have high visual quality from a large range of viewing directions.

### BRIEF SUMMARY OF THE INVENTION

Our research aims to make the process of modeling free-form objects more accurate, more convenient and more robust. The reconstructed models should also exploit compact and smooth graphical surface representations that can be conveniently used for photorealistic rendering. To achieve these goals, we introduce a photogrammetric method for recovering free-form objects with curvilinear structures. To make this method practical for objects without sufficient color or shading variations, we define the topology and recover a sparse 3D wireframe of the object first instead of directly recovering a surface or volume model as in 3D photography. Surface patches covering the object are then constructed to interpolate the curves in this wireframe while satisfying certain heuristics such as minimal bending energy. The result is that we can reconstruct an object model with curvilinear structures from a sparse set of images and can produce realistic renderings of the object model from arbitrary viewpoints.

Constructing a geometric model of an object using our system is an incremental and straightforward process. Typically, the user selects a small number of photographs to begin with, and recovers the 3D geometry of the visible feature points and curves as well as the locations and orientations from which the photographs were taken. Eventually, 3D surface patches bounded by the recovered curves are estimated. These surface patches partially or completely cover the object surface. The user may refine the model and include more images in the project until the model meets the desired level of detail.

Boundary representations are used for representing the reconstructed 3D object models. Every boundary representation of an object implies two aspects: topological and geometric specifications. The topological specification involves the connectivity of the vertices and the adjacency of the faces while the geometric specification involves the actual 3D positions of the vertices and the 3D shapes of the curves and surface patches. The topological information can be obtained without knowing any specific geometric information. In our system, the topology of the reconstructed object evolves with user interactions. The types of user interaction comprise:
Marking a 2D point feature;
Marking the correspondence between two 2D points;
Drawing a 2D curve;
Marking the correspondence between two 2D curves;
Marking a 2D region.

The geometric aspect of the object model is recovered automatically through 3D reconstruction algorithms. A full reconstruction process consists of the following sequential steps (FIG. 1):
the 3D positions of the vertices and all the camera poses are recovered once 2D point features and their correspondences have been marked;
the 3D shapes of all the curves are obtained through robust curve reconstruction algorithms (FIGS. 5(a)&(b));
Depth diffusion or thin-plate spline fitting is used to obtain surface patches for the user-marked regions (FIG. 5(e));
The curves and surface patches are further discretized to produce a triangle mesh for the object (FIG. 5(f));
Texture maps for the triangle mesh are generated from the original input images for synthetic rendering (FIGS. 5(g)&(h)).

We have developed novel methods to reconstruct the 3D geometry of a curve from user marked 2D curve features in multiple photographs. One of the methods robustly recovers unparameterized curves using optimization techniques. The reconstruction of a 3D curve is formulated as recovering one-to-one order preserving point-mapping functions among the 2D image curves corresponding to the 3D curve. An initial solution of the mapping functions is obtained by applying dynamic programming which enforces order preserving mappings. A nonlinear optimization is solved after dynamic programming to obtain the final solution for the mapping functions. The objective function of the nonlinear optimization comprises distances between curve points and the epipolar lines they are supposed to lie on.

Another curve reconstruction method adopts bundle adjustment to recover smooth spline or subdivision curves from multiple photographs. The 3D locations of a small number of control vertices of a 3D spline or subdivision curve are optimized to minimize an objective function which measures the distances between the 2D projections of sample points on the 3D curve in the image planes and the user marked 2D image curves.

### BRIEF DESCRIPTION OF THE DRAWINGS

FIG. 1 Schematic of our photogrammetric reconstruction pipeline.

FIG. 2 During user interaction, three types of features—points, curves (lines) and regions—are marked. The points (little squares) and curves are originally drawn in black on the image planes. Their color changes to green once they are associated with correspondences. A region, shown in red, is marked by choosing a loop of curves.

FIG. 3 The basic principle for obtaining point correspondences across image curves is based on the epipolar constraint. l₁ and l₂ are corresponding epipolar lines in two image planes. The intersections between the image curves and the epipolar lines correspond to each other.

FIG. 4 Uncertainties may arise when solving point correspondences across image curves. (a) There might be multiple intersections between the curve and the epipolar line. (b) The epipolar line might be tangential to the curve (in the image on the right). There is huge amount of uncertainty in the location of the intersection if the curve is locally flat. (c) There might be no intersections between the curve and the epipolar line (in the image on the right) due to minor errors in camera calibration.

FIGS. 5 (a)&(b) Two views of the reconstructed 3D curvilinear structure of the printer shown in FIGS. 2. (c)&(d) The reconstructed curvilinear structures can be projected back onto the input images to verify their accuracy. The user-marked curves are shown in black while the reprojected curves are shown in blue. (e) A triangle mesh is obtained by discretizing the reconstructed spline surface patches. (f) The wireframe of the triangle mesh shown in (e). (g)&(h) Two views of the texture-mapping result for the recovered printer model.

FIG. 6 (a) Two of the four input images used for a couch. (b) The reconstructed 3D curvilinear structure of the couch. (c) The wireframe of the discretized triangle mesh for the couch. (d)&(e) Two views of the texture-mapping result.

FIG. 7 (a) Four of the input images used for an automobile. (b)&(c) Two views of the reconstructed 3D curvilinear structure of the automobile. (d)&(e) Two views of a high-resolution triangle mesh for the automobile. (f)&(g) Two views of the texture-mapping result. The image on the right shows an aerial view from the top.

### DETAILED DESCRIPTION OF THE INVENTION

1. OVERVIEW

1.1. The User's View

Constructing a geometric model of an object using our system is an incremental and straightforward process. Typically, the user selects a small number of photographs to begin with, and recovers the 3D geometry of the visible feature points and curves as well as the locations and orientations from which the photographs were taken. Eventually, 3D surface patches bounded by the recovered curves are estimated. These surface patches partially or completely cover the object surface. The user may refine the model and include more images in the project until the model meets the desired level of detail.

There are two types of windows used in the reconstruction system: image viewers and model viewers. By default, there are two image viewers and one model viewer. The image viewers display two images of the same object at a time and can switch the displayed images when instructed. The user marks surface features, such as corners and curves, as well as their correspondences in the two windows (FIG. 2). Straight lines are considered as a special case of curves. The user marks point features in the images by point-and click; marks curve features by dragging the mouse cursor in the image plane with one of the buttons pressed. Features with and without associated correspondences are displayed in two distinct colors so that isolated features can be discovered easily. The user can also choose a sequence of curves to form the boundary of a region on the object surface. When the user concludes feature and region marking for the set of input images, the computer determines the 3D positions and shapes of the corners and curves that best fit the marked features in the images as well as the locations and orientations of the cameras. A 3D surface patch that interpolates its boundary curves is also estimated for each marked image region.

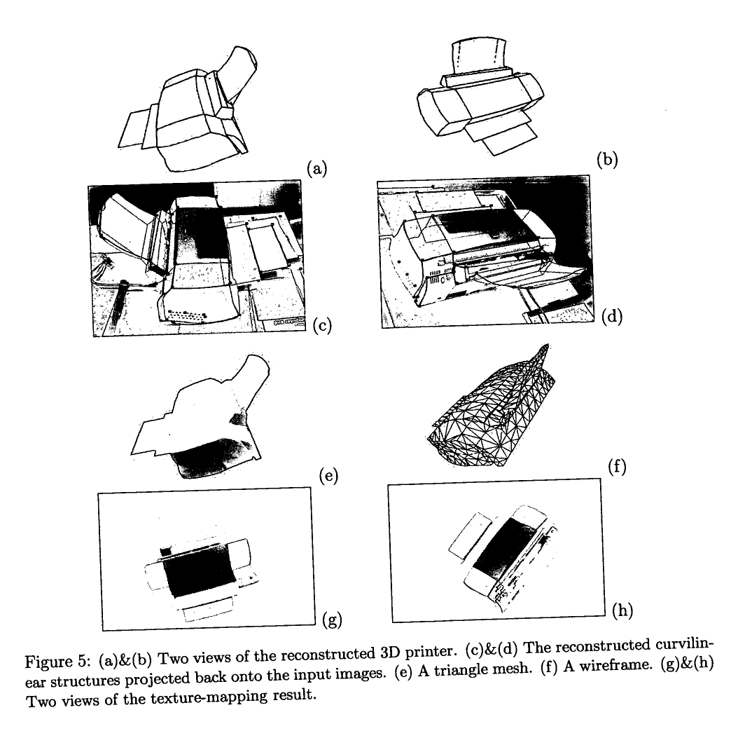

The user can add new images to the initial set, and mark new features and correspondences to cover additional surface regions. The user can choose to perform an incremental reconstruction by computing the camera pose of a new image as well as the 3D information for the features associated with it. Alternatively, a full reconstruction can be launched to refine all the 3D points and curves as well as all the camera poses. An incremental reconstruction is less accurate and takes only a few seconds while a full reconstruction for reasonably complex models takes a few minutes. To let the user verify the accuracy of the recovered model and camera poses, the computer can reproject the model onto the original images (FIGS. 5(c)&(d)). Typically, the projected model deviates from the user-marked features by less than a pixel.

Lastly, the user may generate novel views of the constructed object model by positioning a virtual camera at any desired location. Textures from the original images can be mapped onto the reconstructed model to improve its appearance.

1.2. Model Representation and Reconstruction

We represent the reconstructed 3D object model using boundary representations (B-reps) [17]. Such representations typically consist of three types of primitives: vertices, edges and faces. Edges can be either line segments or curve segments. Faces can be either planar polygons or curved surface patches that interpolate their respective boundary edges. For the same object, our system actually uses two boundary representations for different purposes: a compact and accurate representation with curves and curved surface patches for internal storage, and an approximate triangle mesh for model display and texture-mapping. The triangle mesh is obtained by discretizing the curves and surface patches into line segments and triangles, respectively.

Every boundary representation of an object implies two aspects: topological and geometric specifications. The topological specification involves the connectivity of the vertices and the adjacency of the faces while the geometric specification involves the actual 3D positions of the vertices and the 3D shapes of the curves and surface patches. The topological information can be obtained without knowing any specific geometric information. In our system, the topology of the reconstructed object evolves with user interactions. In the following, let us enumerate the types of user interaction and the corresponding topological changes they incur.
Marking a 2D point feature. A 3D vertex is always created along with every new 2D point feature. The position of this 3D vertex is unknown at the beginning. Every 3D vertex maintains a list of its corresponding 2D points in the images. This list only has one member at first.
Marking the correspondence between two 2D points. The two 3D vertices associated with the two point features are merged into one single vertex. The list of 2D points of the resulting vertex is the union of the original two lists.
Drawing a 2D curve. In our system, an open 2D curve must connect two previously marked points while a closed curve must start and end at the same previously marked point. A 3D curve is also created along with every new 2D curve. The geometry of this 3D curve is unknown at this moment. However, the 3D curve automatically connects the two 3D vertices corresponding to the two endpoints of the 2D curve. Thus, a curved edge is created for the object. Every 3D curve maintains a list of its corresponding 2D curves in the images.
Marking the correspondence between two 2D curves. The two 3D curves associated with the two 2D curves are merged into one single curve. The list of 2D curves of the resulting 3D curve is the union of the original two lists.
Marking a 2D region. A 2D region is defined by a closed loop of 2D curves. When a 2D region is marked, a 3D surface patch is also created. The shape of this surface patch is unknown at this moment. The loop of 2D curves for the 2D region has a corresponding loop of 3D curves which define the boundary edges of the created 3D surface patch.
   This topological evolution has two major advantages:
Correspondence propagation. Once two vertices or curves merge, their corresponding 2D primitives are also merged into a single list. Thus, any two 2D primitives in the resulting list become corresponding to each other immediately without any user interaction.
Consistency check. Marking correspondences is prone to errors. One important type of error is that two primitives belonging to the same image become corresponding to each other after correspondence propagation. This is not allowed because it implies that a 3D point can be projected to two different locations in the same image. This type of error can be easily detected through vertex or curve merging.

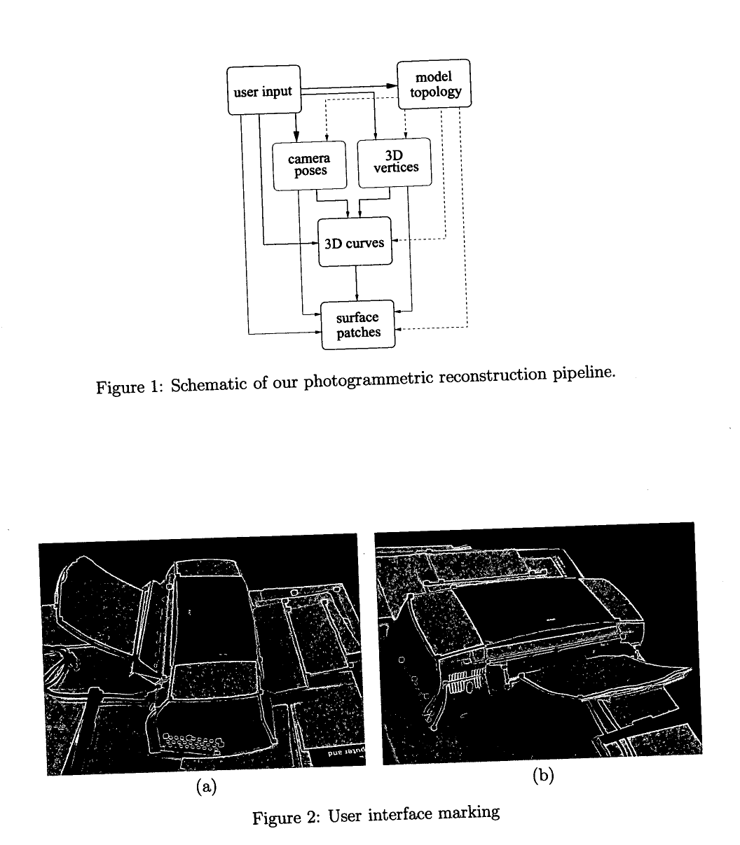

The geometric aspect of the object model is recovered automatically through 3D reconstruction algorithms which will be elaborated in the next few sections. A full reconstruction process consists of the following sequential steps (FIG. 1):
the 3D positions of the vertices and all the camera poses are recovered once 2D point features and their correspondences have been marked;
the 3D shapes of all the curves are obtained through a robust curve reconstruction algorithm (FIGS. 5(a)&(b));
3D thin-plate spline representations of the surface patches are obtained through a surface fitting algorithm (FIG. 5(e));
The curves and spline surface patches are further discretized to produce a triangle mesh for the object (FIG. 5(f));
Texture maps for the triangle mesh are generated from the original input images for synthetic rendering (FIGS. 5(g)&(h)).
   2. Camera Pose and Vertex Recovery

In the first stage of geometric reconstruction, both camera poses and the 3D coordinates of the vertices are recovered simultaneously given user-marked point features and their correspondences. This is analogous to traditional structure-from-motion in computer vision. Therefore, we simply adapt classical computer vision techniques. Unlike structure-from-motion, we only have a sparse set of images while feature correspondences are provided by the user.

Camera poses involve both camera positions and orientations, which are also named external parameters. Besides these external parameters, a calibrated camera also has a set of known intrinsic properties, such as focal length, optical center, aspect ratio of the pixels, and the pattern of radial distortion. Camera calibration is a well-studied problem both in photogrammetry and computer vision; some successful methods include [32]. Although there are existing structure-from-motion techniques for uncalibrated cameras [10], we have found camera calibration to be a straightforward process and using calibrated cameras considerably simplifies the problem.

Given multiple input images with feature correspondences, we start the recovery process by looking for pairs of images with eight or more pairs of point correspondences. The point correspondences can be either user-specified or obtained through correspondence propagation. The relative pose between two cameras can be recovered from the linear algorithm presented in [16]. This algorithm requires that the points used are not coplanar. The major advantage of this algorithm is its linearity which is unlike nonlinear optimization that is likely to get stuck in local minima. Therefore, the user does not need to provide a good initialization through a user interface.

When the relative pose between two cameras have been computed, the system marks a connection between these two cameras. Once all the connections among the cameras have been created, we actually define a graph implicitly with the set of cameras as the nodes and the connections as the edges. The largest connected subgraph is chosen for reconstructing the geometry of the object. An arbitrary camera in this subgraph is chosen to be the base camera whose camera coordinate system also becomes the world coordinate system for the object. The absolute pose of any other camera in the subgraph can be obtained by concatenating the sequence of relative transformations along a path between that camera and the base camera. Once the camera poses have been obtained, the 3D positions of the vertices each of which has at least two associated 2D point features can be calculated by stereo triangulation.

The camera poses and vertex positions thus obtained are not extremely accurate. They serve as the initial solution for a subsequent nonlinear bundle adjustment [31]. Consider a point feature x in an image. Suppose it has an associated 3D vertex with position X, the projection of X in the image should be made as close to x as possible. In bundle adjustment, this principle is applied to all marked image points while refining multiple camera poses and vertex positions simultaneously. We have achieved accurate reconstruction results with bundle adjustment.

3. Curve Reconstruction

We reconstruct curves with the previously recovered camera poses and vertices. In the simplest situation, we have two corresponding image curves in two camera frames. For every pair of corresponding points on the image curves, a point on the 3D curve can be obtained by stereo triangulation. Therefore, the whole 3D curve can be reconstructed if the mapping between points on the two image curves can be obtained.

Let us first review the epipolar constraint before solving the mapping function. Suppose the relative rotation and translation between two camera frames are denoted as R and T. The epipolar constraint between two corresponding points, x₁ and x₂ (in 2D homogeneous coordinates), in the respective two image planes can be formulated as
x₂^{T}\hat{T}Rx₁=0 (1)
where \hat{T} is the skew symmetric matrix for T [19]. This epipolar constraint actually represents two distinct (epipolar) lines in the two image planes. If x₁ is fixed and x₂ is the variable, (1) represents a line equation that the corresponding point of x₁ in the second image should satisfy. Similarly, if we switch the role of x₁ and x₂, (1) represents a line equation in the first image. The distance between x₂ and the epipolar line in the second image can be formulated as

$${D}_{2} ( {x}_{1} , {x}_{2} ) = \frac{\vert {x}_{2}^{T} \hat{T} {Rx}_{1} \vert}{‖ {\hat{e}}_{s} \hat{T} {Rx}_{1} ‖} \\ where {e}_{s} = {[ 0 , 0 , 1 ]}^{T} , and \\ {\hat{e}}_{s} = [ \begin{matrix}0 & - 1 & 0 \\ 1 & 0 & 0 \\ 0 & 0 & 0\end{matrix} ] . \qquad ( 2 )$$

Similarly, The distance between x₁ and the epipolar line in the first image can be formulated as

$${D}_{1} ( {x}_{1} , {x}_{2} ) = \frac{\vert {x}_{2}^{T} \hat{T} {Rx}_{1} \vert}{‖ {x}_{2}^{T} \hat{T} R {\hat{e}}_{s}^{T} ‖} . \qquad ( 3 )$$

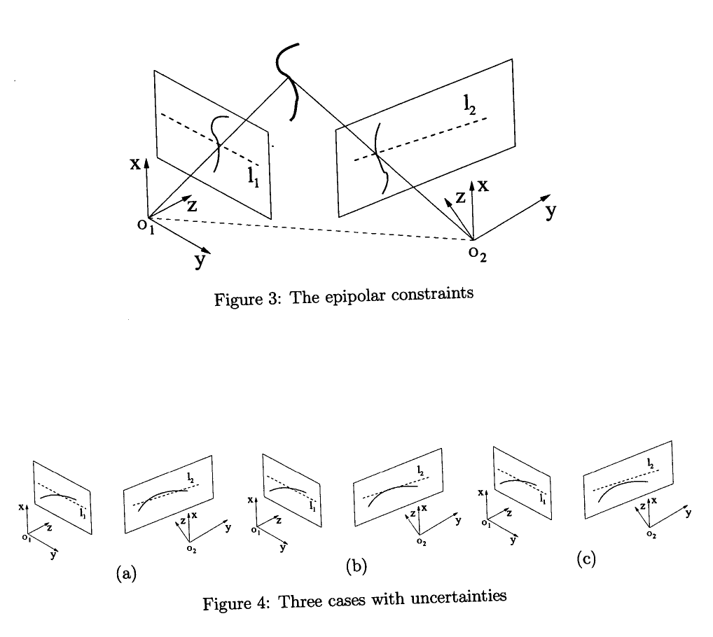

Because of the epipolar constraint, solving the point mapping function between two image curves seems trivial at the first thought. For every point on the first curve, we can obtain an epipolar line in the second image. And the intersection between this line and the second curve is actually the corresponding point on the second curve (FIG. 3). However, this is true only when there is exactly one such intersection. In reality, uncertainties arise because of the shape of the curves and minor errors in the recovered camera poses (FIG. 4). There might be zero or multiple such intersections. In the worst case, the image curve is almost straight but parallel to the epipolar line to cause huge amount of uncertainty in the location of the intersection.

To obtain point correspondences between image curves robustly, we propose to compute one-to-one point mappings in an optimization framework. In general, reconstructions based on multiple views are more accurate than those based on two views because multiple views from various directions can help reduce the amount of uncertainty. Therefore, we discuss general multiple view curve reconstruction as follows. Note an image curve γ(s) can be parameterized by a single variable s ε [a, b]. Consider the general case where there are m corresponding image curves, γᵢ(sᵢ), 0≦i≦m−1, each of which has a distinct parameter sᵢ ε [aᵢ, bᵢ]. Since we require that every curve connects two marked point features, the correspondences among the endpoints of these m curves are known. Without loss of generality, we choose γ₀ as the base curve and assume that γ₀(a₀ ) corresponds to γᵢ(aᵢ), 1≦i≦m−1. Thus, obtaining point correspondences among these m curves is equivalent to solving m−1 mappings, σᵢ(s₀), 1≦i≦m−1, each of which is a continuous and monotonically increasing function that maps [a₀, b₀] to [aᵢ, bᵢ].

Since these curves lie in m different image planes, the relative rotations and translations between the i-th camera frame and the j-th camera frame is respectively denoted as Rᵢⱼ and Tᵢⱼ, 0≦i,j≦m−1. The epipolar constraint between corresponding points on the i-th and the j-th curves requires that
γⱼ(σⱼ(s₀))^{T}\hat{T}ᵢⱼRᵢⱼγᵢ(σᵢ(s₀))=0, s₀ε[a₀,b₀]. (4)
Thus, the desired mappings should be the solution of the following minimization problem,

$${min}_{σ i , 1 \leq i \leq m - 1} {\sum }_{ij , i < j} {\int }_{{a}_{0}}^{{b}_{0}} {( {{γ}_{j} ( {σ}_{j} ( s ) )}^{T} {\hat{T}}_{ij} {R}_{ij} {γ}_{i} ( {σ}_{i} ( s ) ) )}^{2} ⅆ s . \qquad ( 5 )$$

As in bundle adjustment, it is more desirable to minimize projection errors in the image planes directly. In an image plane, satisfying the epipolar constraint is equivalent to minimizing distances similar to those given in (2) and (3). Furthermore, to guarantee that σ(s) is a monotonically increasing one-to-one mapping, σ(s)≦σ(s′) must be held for arbitrary s ε [a, b] and s′ ε [a, b] such that s<s′. To incorporate these considerations, the above minimization problem should be reformulated as

$${min}_{σ i , 1 \leq i \leq m - 1} {\sum }_{ij , i < j} {\int }_{{a}_{0}}^{{b}_{0}} ( \frac{{( {{γ}_{j} ( {σ}_{j} ( s ) )}^{T} {\hat{T}}_{ij} {R}_{ij} {γ}_{i} ( {σ}_{i} ( s ) ) )}^{2} }{{‖ {\hat{e}}_{s} {\hat{T}}_{ij} {R}_{ij} {γ}_{i} ( {σ}_{i} ( s ) ) ‖}^{2}} + \frac{{( {{γ}_{j} ( {σ}_{j} ( s ) )}^{T} {\hat{T}}_{ij} {R}_{ij} {γ}_{i} ( {σ}_{i} ( s ) ) )}^{2} }{{‖ {{γ}_{j} ( {σ}_{j} ( s ) )}^{T} {\hat{T}}_{ij} {R}_{ij} {\hat{e}}_{s}^{T} ‖}^{2}} ) ⅆ s + λ {\sum }_{i} {\int }_{{a}_{0}}^{{b}_{0}} {\int }_{s}^{{b}_{0}} {max}^{2} ( {σ}_{i} ( s ) - {σ}_{i} ( {s}^{′} ) , 0 ) ⅆ {s}^{′} ⅆ s \qquad ( 6 )$$

where the first term addresses the epipolar constraints, the second term enforces that σᵢ(s) is a one-to-one mapping, and λ indicates the relative importance between these two terms. In practice, we have found that λ can be set to a large value such as 10³.

There are practical issues concerning the above minimization. First, before numerical optimization methods can be applied, the integrals should be replaced by summations since each user-marked image curve is actually a discrete set of pixels. A continuous image curve with subpixel accuracy is defined to be the piecewise linear curve interpolating this set of pixels. Given m corresponding image curves, γᵢ(sᵢ), 0≦i≦m−1, to achieve a high precision, we discretize their corresponding 3D curve using the number of pixels on the longest image curve which is always denoted as γ₀(s₀). This scheme basically considers the longest image curve as the 2D parameterization of the 3D curve and there is a depth value associated with each pixel on the longest image curve. Each mapping σᵢ(s) is thus also a discrete function with the same number of entries as the number of pixels on γ₀(s₀). Given a pixel on γ₀(s₀), its corresponding points on other shorter image curves may have subpixel locations. Both the quasi-Newton and conjugate gradient [22] methods can then effectively minimize the discretized cost function. The number of discrete points on each curve is fixed throughout the optimization.

Second, a reasonably good initialization is required to obtain an accurate solution from a nonlinear formulation. In practice, we parameterize the image curves using their arc lengths. For the mapping functions we seek, the linear mapping between two parameter intervals is one of the possible initializations. But we actually initialize the mappings using dynamic programming which is particularly suitable for order-preserving one-dimensional mappings. We initialize each σᵢ(s) independently using only two curves (γ₀ and γᵢ) and adopt the discrete version of the first term in (6) as the cost function for dynamic programming while enforcing one-to-one mapping as a hard constraint which means only order-preserving mappings are admissible. Specifically, we represent each curve γᵢ as a discrete set of pixels, pᵢ^{k}, 0≦k≦nᵢ, where nᵢ is the number of pixels on the curve. Dynamic programming recursively computes the overall mapping cost. The cumulative cost between a pair of pixels on the two curves is defined as

$${C}_{dp} ( {p}_{0}^{k} , {p}_{i}^{l} ) = D ( {p}_{0}^{k} , {p}_{i}^{l} ) + {min}_{τ ∈ {S}_{kl}} {C}_{dp} ( {p}_{0}^{k - 1} , {p}_{i}^{τ} ) \qquad ( 7 )$$

where D(p₀^{k}, pᵢ^{l})=D₁(p₀^{k}, pᵢ^{l})+D₂(p₀^{k}, pᵢ^{l}), and Sₖₗ contains all admissible values of r under the condition that p₀^{k} matches pᵢ^{l}.

In terms of closed image curves, the mapping functions can be solved similarly as long as there is one point feature on each of them and the point features correspond to one another. This is because the point feature on each curve can be considered as the starting point as well as the ending point. Nevertheless, the mapping functions can still be solved without any predefined point features on the curves. Consider one point p₀ on the base curve γ₀, ideally the epipolar line of this point may intersect with γᵢ at one or multiple locations. Having only one intersection means the epipolar line is tangential and locally parallel to γᵢ while errors in the camera poses may also lead to zero intersections. Both of these cases can cause uncertainty. Therefore, we should move p₀ along γ₀ until there are at least two well separated intersections. One of these intersections is the point on γᵢ that corresponds to p₀. For each of the intersections, we can first assume it is corresponding to p₀, and then solve the optimal mapping function between the two curves based on that assumption. Each of the optimal mapping functions thus obtained has an associated cost. The intersection with the minimal associated cost should be the correct corresponding point. And the optimal mapping function for that intersection should be the correct mapping between y₀ and yᵢ. In this way, mapping functions among closed image curves can be recovered.

Once we have obtained all the mapping functions, for every s₀ ε [a₀, b₀], there is a set of corresponding image points, γᵢ(σᵢ(s₀)), 0≦i≦m−1. The 3D point corresponding to this list of 2D points can be obtained using bundle adjustment. At the end, all the 3D points recovered in this way form the reconstruction of a 3D curve. This reconstructed 3D curve is essentially unparameterized. If necessary, it is straightforward to fit a smooth parameterized 3D curve such as a spline to this unparameterized curve.

When smooth curves are desirable, we can actually perform a novel bundle adjustment to directly fit a smooth curve to the set of image curves. This is more accurate than fitting a smooth curve to the previously recovered unparameterized curve which may contain significant errors because of the large number of unknowns in the unparameterized curve. The smooth curves can be either spline curves or subdivision curves. The shape of both types of curves are controlled by a small number of control vertices. We consider the set of 3D control vertices Xᵢ^{c}, i=0, 1, . . . , M, as the unknowns. A smooth curve can be generated from this set of control vertices. A dense set of points sampling the generated curve are denoted as, xᵢ^{s}, i=0, 1, . . . , N. A sample point xᵢ^{s} can be projected into the m image planes to obtain m projected 2D points yᵢⱼ^{p}, j=0, 1, . . . m. Ideally, yᵢⱼ^{p} should lie on the image curve yⱼ. In practice, there is likely to be a nonzero distance between the projected point and the image curve. We would like to minimize this type of distance by searching for the optimal 3D control vertices. In summary, we would like to solve the following minimization problem,

$${min}_{{x}_{i}^{c} , 0 \leq i \leq M} {{\sum }_{i = 0}}^{N} {{\sum }_{j = 0}}^{m - 1} dist ( {y}_{ij}^{p} , {γ}_{j} ) \qquad ( 8 )$$

where dist(p, γ) represents the minimum distance between a point and a curve. In practice, we adopted a type of interpolative subdivision curve [37] and have obtained very accurate 3D smooth curve reconstruction by solving the minimization problem in (8).
4. Surface Reconstruction

In the reconstruction system, every surface patch is defined by a closed loop of 2D boundary curves. The boundary curves need to be marked in the same image, and they enclose a 2D image region which we actually adopt as the parameterization for the target surface patch. Because of this parameterization, the surface patch is a depth function defined on the image plane in the local camera coordinate system. Therefore, recovering the surface patch has been reduced to estimating a depth value at every pixel inside the closed image region. The estimated surface patch can be represented in the world coordinate system by simply applying the transformation between the camera's local frame and the world frame.

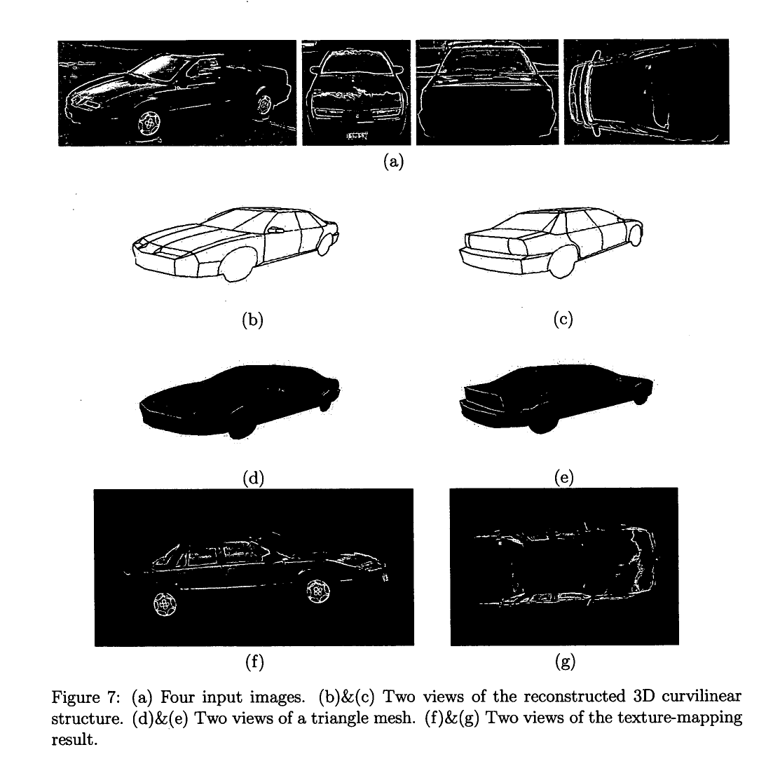

There are different choices for estimating the depth function in the local camera frame. If the original object surface has rich texture, but not highly reflective or translucent (as the object in FIG. 7), the first option would try to estimate a dense depth field using a version of the stereo reconstruction algorithm [27] that is based on anisotropic diffusion of the depth values. It imposes a regularization term to guarantee depth smoothness at the same time preserves depth discontinuities. Such an algorithm requires that there is at least another image of the same surface region. Since the depth on the boundary curves have already been recovered, these known depths serve as a boundary condition for the regularization term. The algorithm in [27] can be easily extended to incorporate more than two views of the surface.

On the other hand, if the original object surface has very sparse point features or no features at all, estimating a dense depth field becomes infeasible. In this case, we designed two methods. In the first one, we solve the Laplacian equation for depth using the depth values on the boundary curves as the boundary condition. This is equivalent to simulating anisotropic diffusion[21] on depth until convergence with diffusion coefficients over the boundary curves set to zero. Solving the Laplacian equation using a multiresolution pyramid for each image can significantly improve the convergence rate. Intuitively, this method looks like smoothly propagating the depth from the boundary curves towards the interior of the region until an equilibrium state has been reached.

In the second method, we choose to fit a thin plate spline (TPS) surface to the boundary depth values as well as the depths at the sparse set of interior features if there are any. Since the thin plate spline model minimizes a type of bending energy, it is smooth and would not generate undesirable effects in featureless regions. We only use one single view for TPS fitting. In practice, our system chooses the image with the most frontal-facing view of the surface region. The reason that we only need one single view for TPS fitting is related to the type of objects we choose to focus on in this paper. As mentioned previously, the feature curves are responsible for creating the correct occlusions between foreground and background objects as well as between different parts of the same object. Therefore, the visual shape of an object is very well captured by these curves. The surface patches inbetween these curves only need to be reconstructed to a less degree of accuracy. Necessary conditions for avoiding visual artifacts and inconsistencies are that the surface patches should interpolate their boundary curves and should be smooth without obviously extruding vertices because extruding vertices modify the occluding contours and silhouettes of the object and can be noticeable.

The thin plate spline model is commonly used for scattered data interpolation and flexible coordinate transformations [34, 12, 24]. It is the 2D generalization of the cubic spline. Let vᵢ denote the target function values at corresponding locations xᵢ in an image plane, with i=1, 2, . . . , n, and xᵢ in homogeneous coordinates, (xᵢ, yᵢ, 1). In particular, we will set vᵢ equal to the depth value at xᵢ to obtain a smooth surface parameterized on the image plane. We assume that the locations xᵢ are all different and are not collinear. The TPS interpolant f (x, y) minimizes the bending energy
I_{f}=∫∫fₓₓ²+2f_{xy}²+f_{yy}²dxdy (9)
and has the form:

$$f ( x ) = {a}^{T} x + {{\sum }_{i = 1}}^{n} {w}_{i} U ( ‖ {x}_{i} - x ‖ ) \qquad ( 10 )$$

where a is a coefficient vector and wᵢ's are the weights for the basis function U(r)=r² log r. In order for f(x) to have square integrable second derivatives, we require that

$${{\sum }_{i = 1}}^{n} {w}_{i} {x}_{i} = 0 \qquad ( 11 )$$

Together with the interpolation conditions, f(xᵢ)=vᵢ, this yields a linear system for the TPS coefficients:

$$( \begin{matrix}K & P \\ {P}^{T} & 0\end{matrix} ) ( \frac{w}{a} ) = ( \frac{υ}{0} ) \qquad ( 12 )$$

where Kᵢⱼ=U(||xᵢ−xⱼ||), the ith row of P is xᵢ^{T}, w and v are column vectors formed from wᵢ and vᵢ, respectively, and a is the coefficient vector in (10). We will denote the (n+3)×(n+3) matrix of this system by L. As discussed e.g. in [24], L is nonsingular and we can find the solution by inverting L. If we denote the upper left n×n block of L⁻¹ by A, then it can be shown that I_{f}∝v^{T} Av=w^{T} Kw.

When there is noise in the specified values vᵢ, one may wish to relax the exact interpolation requirement by means of regularization. This is accomplished by minimizing

$$E ( f ) = {\sum }_{i} {( {v}_{i} - f ( {x}_{i} ) )}^{2} + β {I}_{f} . \qquad ( 13 )$$

The regularization parameter β, a positive scalar, controls the amount of smoothing; the limiting case of β=0 reduces to exact interpolation. As demonstrated in [34], we can solve for the TPS coefficients in the regularized case by replacing the matrix K by K+βI, where I is the n×n identity matrix.
5. Mesh Construction and Texture Mapping

We actually obtain a triangle mesh for texture mapping by discretizing the estimated surface patches. To avoid T-junctions in the resulting mesh, we require that two adjacent surface patches sharing the same curve should be discretized such that the two sets of triangles from the two patches have the same set of vertices on the curve. We satisfy this requirement by discretizing the curves first. Given an error threshold, each curve is approximated by a polyline such that the maximum distance between the polyline and the original curve is below the threshold. Thus, the boundary of a surface patch becomes a closed polyline. Since each surface patch has a marked region as its parameterization in one of the input images, the 3D boundary polyline of a patch is reprojected onto that image to become a boundary polyline for the marked region. A constrained Delaunay triangulation (CDT) is then constructed to triangulate the image region while keeping its boundary polyline. This planar triangulation is elevated using the surface depth information to produce the final triangulation for the 3D surface patch.

For rendering and manipulation, meshes with attached texture maps are used to represent objects. Given camera poses of the photographs and the mesh of an object, we can extract texture maps for the mesh and calculate the texture coordinates of each vertex in the mesh. We use conventional texture-mapping for the objects, which means each triangle in a mesh has some corresponding triangular texture patch in the texture map and each vertex has a pair of texture coordinates which is specified by its corresponding location in the texture map.

Since each triangle in a mesh may be covered by multiple photographs, we actually synthesize one texture patch for each triangle to remove the redundancy. This texture patch is the weighted average of the projected areas of the triangle in all photographs. The weight for each original area from photographs is set in such a way that the weight becomes smaller when the triangle is viewed from a grazing angle or its projected area is close to the boundaries of the photograph to obtain both good resolution and smooth transition among different photographs. Visibility is determined using Z-buffer for each pixel of each original area to make sure only correct colors get averaged. We place the synthetic triangular texture patches into texture maps, and therefore obtain texture coordinates. In order to maintain better spatial coherence, we can optionally generate one texture patch for an entire surface region and place it into the texture maps. The texture coordinates assigned to the vertices in the surface region represent a planar 2D parameterization for the surface region. Such a texture patch can keep the original relative positions among all the triangles in the surface region.

The colors for triangles invisible in all of the photographs can be obtained by propagating the colors from nearby visible triangles. This is an iterative process because invisible triangles may not have immediate neighboring triangles with colors at the very beginning. If an entire triangle is invisible, a color is obtained for each of its vertices through propagation. This color is a weighted average of the colors from the vertex's immediate neighbors with the weight in inverse proportion to their distance. If a triangle is partially visible, it is still allocated with a texture patch and the holes are filled from the boundaries inwards in the texture map. The filled colors may be propagated from neighboring triangles since holes may cross triangle boundaries.

To reduce the amount of data, the generated texture maps are considered as images and further compressed using a lossless and/or lossy compression scheme. In practice, we use the JPEG image compression standard and can achieve a compression ratio of 20:1 without obvious visual artifacts.

6. Reconstruction Examples

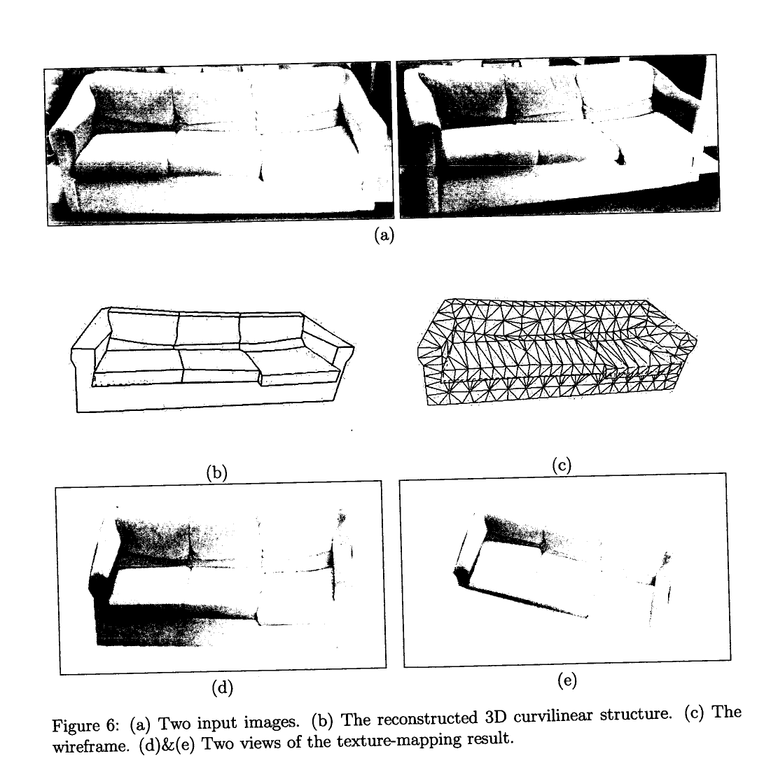

We have reconstructed multiple objects using our interactive reconstruction system. The results are shown in FIG. 5-7. The more views of an object we use, a more complete 3D model we can recover. Because of our emphasis on salient curves, a texture-mapped model can faithfully reproduce the original appearances of an object even from a very sparse set of images. This is demonstrated in FIG. 6. From the reconstructed curvilinear structures shown in FIG. 5-7, it is clear that these structures provide a compact shape description of the type of objects considered in this paper. The thin-plate spline surfaces estimated using these curves have high visual quality for texture-mapping. Synthetically rendered images of the reconstructed models can be generated from arbitrary viewpoints.

There is a fair amount of user interaction in our method. However, it is justified by the difficulty of automatic detection of high-curvature feature curves which are mostly geometric features instead of pixel intensity features. Automated feature detection is only possible when there are reasonable pixel intensity variations across the curves. For example, in FIG. 6, the whole object has a more or less uniform color and it is infeasible to detect some of the user-marked curves automatically if they do not happen to be intensity features. Nevertheless, humans can locate these curves using their prior knowledge of the object. Also in FIG. 7, the strong specular reflectance of the object surface produces many reflected textures which would significantly interfere with automatic surface curve detection. Therefore, we mean “salient curves” from a human perspective instead of from the machines'. When a free-form object do not seem to have recognizable salient curves from a human observer, our approach becomes inappropriate for its reconstruction.

As shown in FIG. 5(c)-(d), the user can verify the accuracy of the recovered vertices and curves by reprojecting them back onto the original images. Usually, the projected vertices and curves deviate from the user-marked features by one pixel or less. Actually, the user does not have to be extremely careful in feature marking to achieve this accuracy. Typically, one only needs to mark a sparse set of key points on a curve and a spline interpolating these key points would be sufficient. In summary, such an accuracy is achieved through multiple measures in image acquisition, automatic 3D reconstruction and user interaction:
The baseline between every pair of images should be relatively large. As in stereopsis, a large baseline makes the reconstruction less sensitive to errors in feature location.
There should be at least one baseline not parallel to each surface curve. Otherwise, the curve reconstruction algorithms would not produce acceptable results.
We use bundle adjustment in both camera pose estimation and curve reconstruction to make the final reconstruction less sensitive to errors in individual feature marking.
The reprojected feature locations provide feedback to the user who can move a marked feature to a more accurate position once a marking error has been discovered. Thus, a user marking error behaves like an outlier in the reconstruction process and can be interactively eliminated.

Note that lines are a special case of curves. A 3D line segment can be obtained immediately once its two endpoints have been recovered. We use line segments whenever appropriate because of the convenience they provide.

1. Methods to reconstruct the 3D geometry of a curve from user marked 2D curve features in multiple photographs.

2. The methods of claim 1 comprises a robust method for recovering unparameterized curves from multiple photographs using optimization techniques.

3. The methods of claim 1 also comprises an efficient bundle adjustment method for recovering smooth spline or subdivision curves from multiple photographs.

4. The method of claim 2, wherein the reconstruction of a 3D curve is formulated as recovering one-to-one order preserving point-mapping functions among the 2D image curves corresponding to the 3D curve.

5. The method of claim 4, wherein an initial solution of the mapping functions for 3D curve reconstruction is obtained by applying dynamic programming which enforces order preserving mappings.

6. The method of claim 4, wherein a nonlinear optimization is solved after dynamic programming to obtain the final solution for the mapping functions.

7. The method of claim 6, wherein the objective function of the nonlinear optimization comprises distances between curve points and the epipolar lines they are supposed to lie on.

8. The method of claim 3, wherein the 3D locations of a small number of control vertices of a 3D spline or subdivision curve are optimized to minimize an objective function which measures the distances between the 2D projections of sample points on the 3D curve in the image planes and the user marked 2D image curves.

9. A photogrammetric method and system for reconstructing 3D virtual models of real objects with curvilinear structures, from a sparse set of photographs of the real objects and producing realistic renderings of the virtual object models from arbitrary viewpoints.

10. The method of claim 9, comprising:
(a) the user selection of a small number of photographs of the target object to begin with, and the user interaction of marking a plurality of feature points, curves, and their correspondences on the selected photographs;
(b) a method to recover the 3D geometry of the marked feature points as well as the locations and orientations of the camera from which the photographs were taken;
(c) recover the 3D geometry of the user marked curves using methods in claim 1;
(d) methods to calculate 3D surface patches bounded by the recovered curves;
(e) a method to construct, compress and render texture maps for the recovered 3D model;
(f) a method to allow users to refine the 3D model and include more images until the model meets the desired level of detail.

11. The method of claim 9, wherein the reconstruction comprises a topological evolution process underlying user interactions to obtain implicit feature correspondences and perform consistency check among all the correspondences.

12. The method of claim 9, wherein the reconstruction comprises a graph-based approach to obtain the camera poses for a sparse set of photographs.

13. The method of claim 9, wherein the reconstruction comprises a method for estimating the depth of a surface patch by propagating and diffusing the recovered depth values at a sparse set of curves and points.

14. The method of claim 9, wherein the reconstruction comprises a method for generating a smooth surface patch by fitting a thin-plate spline to the recovered depth values at a sparse set of curves and points.

15. The method of claim 9, wherein the reconstruction comprises a method for constructing a complete triangle mesh for a recovered 3D model by computing a constrained Delaunay triangulation for each surface patch of the model.

16. The method of claim 9, wherein the reconstruction comprises the use of two boundary representations for the same object for different purposes:
(a) a compact and accurate representation with curves and curved surface patches for internal storage;
(b) an approximate triangle mesh for model display and texture mapping.

17. The method of claim 9, wherein the reconstruction comprises a method for constructing texture maps for a recovered 3D model and a method for compressing the obtained texture maps.

18. The user interaction of claim 10, further comprising
(a) marking point features in two or more images of the same object at a time;
(b) marking the correspondence between the point features;
(c) marking curve (including straight line) features in two or more images of the same object at a time;
(d) marking the correspondences of curves between the curve features;
(e) marking region features by selecting a sequence of curves to form the boundary of a region on the object surface.

19. The method of claim 10, wherein it provides the user the capability to add new images to the initial photograph set, and mark new features and correspondences to cover additional surface regions, is critical for its practical use and commercialization.

20. The method of claim 10, further comprises two alternative approaches:
(a) incremental reconstruction for faster result, wherein only computing the camera pose of a new image and the 3D information for the features associated with it;
(b) full reconstruction for better accuracy, wherein computing all the 3D points and curves as well as all the camera poses.

21. The method of claim 10, wherein the user may generate novel views of the constructed object model by positioning a virtual camera at any desired location.

22. The method of claim 11, wherein the improvement comprises automatic correspondence propagation and consistency check.

23. The method of claim 11, wherein the improvement comprises a method to fill in colors for triangles invisible in all of the photographs.
